(19) United States
(12) Patent Application Publication
(10) Pub. No.: US 2026/0329524 A1
(43) Pub. Date: Oct. 22, 2026

(54) MODIFYING AUDIO DEVICE OPERATION BASED ON SLEEP STATE DETECTION

(71) Applicant: Apple Inc., Cupertino, CA (US)

(72) Inventors: Sudeep Dattatraya KULKARNIIRLEKAR, Santa Clara, CA (US); Claire Therese HAGAN, San Diego, CA (US); Frederick A. WACHTER, Sunnyvale, CA (US); Sang Jun LEE, Los Altos, CA (US); Deepak IYER, Mountain View, CA (US); Prateek MURGAI, San Francisco, CA (US); Kapil KRISHNAMURTHY, Sunnyvale, CA (US)

(21) Appl. No.: 19/542,571

(22) Filed: Feb. 17, 2026

Related U.S. Application Data
(60) Provisional application No. 63/790,687, filed on Apr. 17, 2025.

(51) Int. Cl. G06F 3/16; H04R 1/10; H04R 3/04

(52) U.S. Cl. CPC G06F 3/165; H04R 1/10; H04R 3/04; H04R 2420/07; H04R 2430/01; H04R 2460/01; H04R 2460/03

(57) ABSTRACT

Implementations of the subject technology provide systems and methods for modifying audio device operation based on sleep detection. Audio devices, such as earbuds or headphones, may modify the output generated by their speakers when a sleep state of a wearer of the audio device(s) is identified by the audio device. Modifying the output may include pausing output of media content, reducing volume, modifying equalization, modifying noise cancellation operations, modifying pass-through audio operations, and/or other modifications.

### CROSS REFERENCE TO RELATED APPLICATIONS

This application claims the benefit of priority to U.S. Provisional Patent Application No. 63/790,687, entitled, “Modifying Audio Device Operation Based on Sleep State Detection”, filed on Apr. 17, 2025, the disclosure of which is hereby incorporated herein in its entirety.

### TECHNICAL FIELD

The present description relates generally to audio devices and, more particularly, for example, to modifying audio device operation based on sleep detection.

### BACKGROUND

Audio devices such as headphones and earbuds are often worn by a user to output music and to provide noise cancellation.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 is a schematic diagram illustrating an audio device modifying its audio output based on an identified sleep state in accordance with implementations of the subject technology.

FIG. 3 is a schematic diagram illustrating an audio device providing an indication of a sleep state to a companion device, and receiving a control signal to modify its audio output based on the sleep state in accordance with implementations of the subject technology.

FIG. 4 is a schematic diagram illustrating various devices that can be controlled based on a sleep state detected by an audio device

in accordance with one or more implementations of the subject technology.

FIG. 5 is a flow diagram for an example process for operating an audio device based on an identified sleep state in accordance with one or more implementations of the subject technology.

FIG. 6 is a flow diagram for another example process for operating an audio device based on an identified sleep state in accordance with one or more implementations of the subject technology.

FIG. 7 is a flow diagram for yet another example process for operating an audio device based on an identified sleep state in accordance with one or more implementations of the subject technology.

FIG. 8 is a flow diagram for an example process for operating a source device based on an identified sleep state in accordance with one or more implementations of the subject technology.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Implementations of the subject technology described herein provide for modifications to the operation of an audio device, such as an earbud or a headphone, responsive to a detection that a wearer of the audio device may be falling asleep, or may have fallen asleep. In one or more implementations, modifications to the operation of an audio device may include modifying output of media content (e.g., pausing media playback, reducing volume of playback, modifying playback for hearing protection, and/or modifying playback equalization (EQ)), modifying the control of external sounds that pass through the earbud/headphones (e.g., modifying an active noise cancellation (ANC) operation, and/or modifying which set of selected sounds are allowed to pass through), modifying speaker control to aid a user in falling asleep (e.g., if a transitional sleep state is detected), and/or modifying speaker control to aid a user in staying awake (e.g., if a transitional sleep state is detected) or waking up (e.g., if a sleeping state is detected). In one or more implementations, control of other network-connected devices, such as lights, door locks, and/or Internet-of-Things (IoT) devices, may be performed by a device when a sleep state is detected by an audio device.

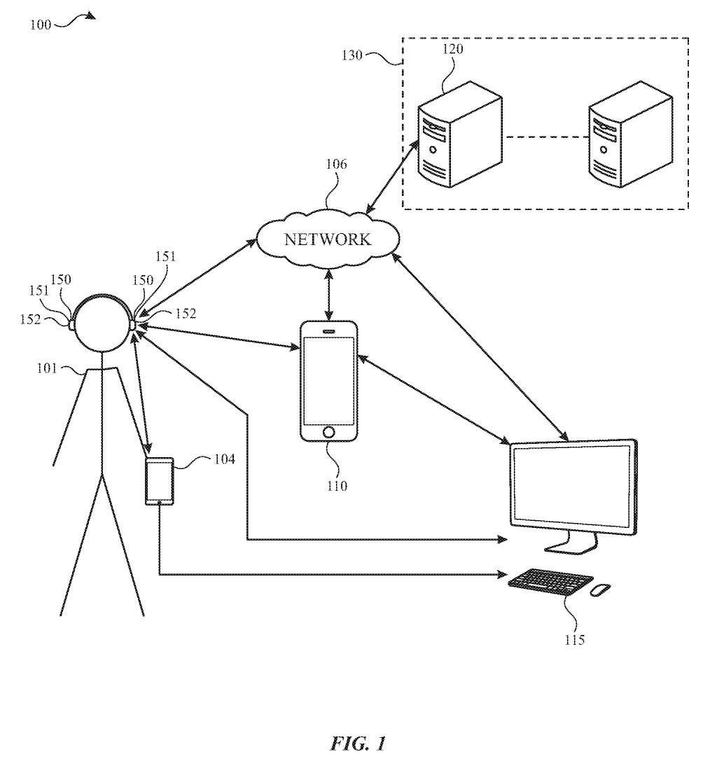

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio device 150, an electronic device 104 (e.g., a handheld electronic device such as a smartphone or a tablet), an electronic device 110, an electronic device 115, and a server 120 communicatively coupled by a network 106 (e.g., a local or wide area network). For explanatory purposes, the system architecture 100 is illustrated in FIG. 1 as including the audio device 150, the electronic device 104, the electronic device 110, the electronic device 115, and the server 120; however, the system architecture 100 may include any number of electronic and/or audio devices and any number of servers or a data center including multiple servers.

The audio device 150 may be implemented as headphones (e.g., a pair of speakers mounted in speaker housings that are coupled together by a headband) or an earbud (e.g., an earbud of a pair of earbuds each having a speaker disposed in a housing that conforms to a portion of the user’s ear) configured to be worn by a user (also referred to as a wearer when the audio device is worn by the user). Each audio device 150 may include one or more speakers, such as a speaker 152 configured to project sound into an ear of the user 101, and one or more sensors such as a sensor 151. Sensor 151 may include one or more microphones configured to receive audio inputs (e.g., based on a user’s own voice, environmental sounds, and/or other external voice inputs). Sensor 151 may include other sensors, such as inertial measurement unit (IMU) sensors (e.g., accelerometers, magnetometers, and/or gyroscopes). In one or more implementations, the audio device 150 may be integrated with and/or communicatively coupled with (e.g., and co-operable) with another device, such as a head mountable device (HMD) that includes one or more displays for displaying visual content (e.g. a movie, a show, other video content and/or gaming content) that corresponds to audio content being output by the audio device 150.

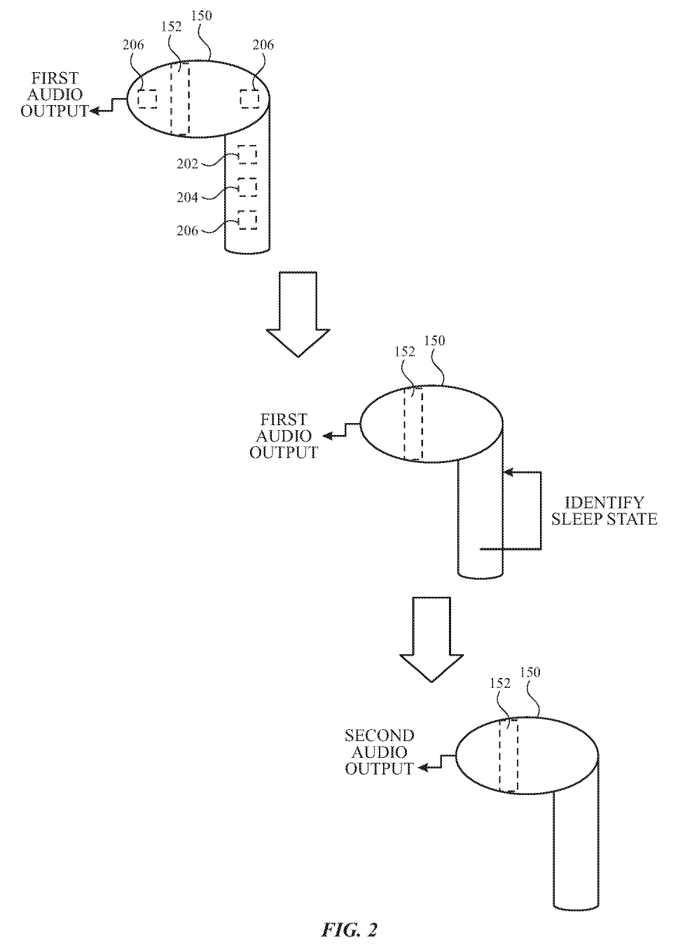

Although not visible in FIG. 1 (see, e.g., FIG. 2), each audio device may include processing circuitry (e.g., including memory and/or one or more processors) and communications circuitry (e.g., one or more antennas, etc.) for receiving and/or processing audio content and/or control signals from one or of the electronic device 104, the electronic device 110, the electronic device 115, and/or the server 120, and/or for transmitting sleep state information to the electronic device 104, the electronic device 110, the electronic device 115, and/or the server 120. The processing circuitry of the audio device 150 may operate the speaker 152 to generate the sound. The memory may store one or more machine learning models and/or one or more rules-based processes for identifying a sleep state of a user 101 (e.g., a wearer) that is wearing the audio device 150 (e.g., based on detected motions of the user, as determined using the IMU sensor(s) and/or based on the user’s breathing, heartrate, etc., as determined using the microphone(s) and/or the IMU sensor(s) of the audio device 150 and/or one or more other devices, such as a smart watch, a smart ring, or a head mountable device, that is/are communicatively coupled to the audio device 150 and/or a companion device, such as the electronic device 104).

The audio device 150 may include communications circuitry for communications (e.g., directly or via network 106) with the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The electronic device 104 , the electronic device 110, an electronic device 115, and/or the server 120 may include communications circuitry for communications (e.g., directly or via network 106) with audio device 150 and/or with the others of the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios.

In one or more implementations, the audio device 150 may also include one or more machine learning models that are trained to recognize the voice of user 101, any of various verbal commands from the voice of user 101, and/or any of various standardized sounds such as police or ambulance sirens, smoke or fire alarms, and/or travel announcements (e.g. station announcements, or bus stop announcements).

The audio device 150 may be communicatively coupled to a companion device, such as the electronic device 104, the electronic device 110, and/or the electronic device 115. Such a companion device may, in general, include more computing resources and/or available power in comparison with the audio device 150. In one or more implementations, memory of the electronic device 104, the electronic device 110, and/or the electronic device 115 may store one or more machine learning models for identifying a sleep state of a user 101 (e.g., a wearer) and/or for generating control signals for the audio device 150 based on information received from the audio device 150. The electronic device 104, the electronic device 110, and/or the electronic device 115 may also include one or more machine learning models that are trained to recognize the voice of user 101, any of various verbal commands from the voice of user 101, and/or any of various standardized sounds such as police or ambulance sirens, smoke or fire alarms, travel announcements (e.g. station announcements, or bus stop announcements), based on audio data received from the audio device 150.

The audio device 150 may operate in various modes. For instance, the audio device 150 can operate in a first mode of operation (e.g., a transparent mode of operation), in which environmental sounds are passed, by the speaker(s) of the audio device 150, through to the ear(s) of the user 101. In this first mode of operation, media content (e.g., received from electronic device 104) may be played without noise-cancelling content and to allow and/or enhance external sounds for pass-through to the user while the audio content plays. The audio device 150 may operate in a second mode of operation (e.g., a noise-cancelling mode of operation, such as an active noise cancellation (ANC) operation, which may be an adaptive ANC operation that uses an error signal from an error microphone to adaptively cancel residual environmental noise) in which environmental sounds received by one or more microphones of the audio device 150 are cancelled, to prevent the environmental sounds from reaching the ear of the user 101. In this second mode of operation, media content (e.g., music, podcasts, audio associated with an application, a game, a video, etc.) may be played combined with noise cancellation content by the audio device (e.g., noise cancelling content that is generated, based on environmental sounds received by one or more microphones of the audio device 150 to destructively interfere with, and thereby cancel, the environmental sounds).

Audio device 150 may also include one or more sensors such as touch sensors and/or force sensors for receiving user input. For example, a user/wearer of audio device 150 may tap a touch sensor or pinch the force sensor briefly to control the audio content being played, to control volume of the playback, and/or to toggle between the transparent and noise-cancelling modes of operation. In one or more implementations, the user may hold down the force sensor while the audio device is operated in the noise-cancelling mode of operation to temporarily switch to the transparent mode of operation until the force sensor is released. In one or more implementations, the user 101 may provide an input to the sensor(s) 151 to enable or disable a sleep detection and/or modifications based on sleep detection at the audio device 150.

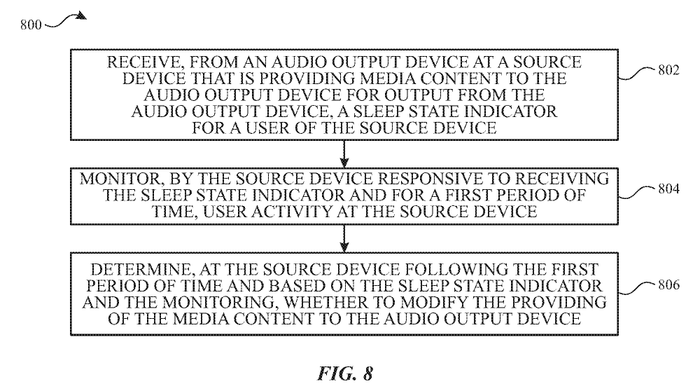

The electronic device 104 may be, for example, a smartphone, a portable computing device such as a laptop computer, a peripheral device (e.g., a digital camera, headphones), a tablet device, a wearable device such as a smart watch, a smart band, and the like, any other appropriate device that includes, for example, processing circuitry and/or communications circuitry for providing audio content to audio device(s) 150. In FIG. 1, by way of example, the electronic device 104 is depicted as a mobile smartphone device with a touchscreen. In one or more implementations, the electronic device 104 and/or the audio device 150 may be, and/or may include all or part of, the electronic device discussed below with respect to the electronic system discussed below with respect to FIG. 8.

The electronic device 115 may be, for example, desktop computer, a portable computing device such as a laptop computer, a smartphone, a peripheral device (e.g., a digital camera, headphones), a tablet device, a home hub device, or a wearable device such as a watch, a band, and the like. In FIG. 1, by way of example, the electronic device 115 is depicted as a desktop computer. However, this is merely illustrative. In some implementations, the electronic device 115 may be implemented as a home-control device (e.g., a hub device or other device) that is communicatively coupled to one or more network-connected devices in a home or building, and that is configured to generate control signals for operating the one or more network-connected devices. The electronic device 115 may be, and/or may include all or part of, the electronic system discussed below with respect to FIG. 8.

The server 120 may form all or part of a network of computers or a group of servers 130, such as in a cloud computing or data center implementation. For example, the server 120 stores data and software, and includes specific hardware (e.g., processors, graphics processors and other specialized or custom processors, such as for user authentication and/or authorization, account services, and/or streaming media content to the electronic device 104, the electronic device 110, and/or the electronic device 115. In an implementation, the server 120 may function as a cloud storage server.

FIG. 2 illustrates an example use case in which the audio device 150 outputs a first audio output. In one example, the first audio output may include media content, such as music, a podcast, or an audio track corresponding to a video stream or a game. In other examples, the first audio output may include noise cancellation content. For example, the noise cancellation content may be content that is generated to destructively interfere with environmental sounds (e.g., to cancel those environmental sounds before they reach the ear of the wearer). In some examples, the first audio content can include a combination of media content and noise cancellation content. In some example, the first audio output may include pass-through audio of environmental sounds. For example, environmental sounds that would otherwise be physically blocked by the presence of the audio device 150 in or around the ear of the wearer can be detected by one or more microphones of the audio device 150, and reproduced by the speaker(s) 152 of the audio device 150 (e.g., to provide the wearer with the sensation that the audio device 150 is acoustically transparent and does not block environmental sounds). In some examples, only selected environmental sounds may be passed through in some portions of the first audio output, and other environmental sounds can be blocked or cancelled by other portions of the first audio output.

As shown in FIG. 2, the audio device 150 may include processing circuitry 202, one or more sensors 204, and/or one or more microphones 206. For example, the sensors 204 and the microphones 206 may be implementations of the sensors 151 of FIG. 1. As shown, the audio device 150 may include multiple microphones 206. The multiple microphones 206 may include a microphone 206 positioned (e.g., behind the speaker 152) to receive environmental sounds, a microphone 206 positioned (e.g., nearest to the wearer’s mouth) voice input from the wearer, and/or a microphone 206 positioned (e.g., in front of the speaker 152) as an error microphone for detecting sounds (e.g., residual, or uncancelled environmental sounds) in or near the ear canal of the wearer. The sensor(s) 204 may include inertial measurement unit (IMU) sensors (e.g., accelerometers, magnetometers, and/or gyroscopes), proximity sensors, touch sensors, force sensors, and/or other sensors.

In the example of FIG. 2, while generating the first audio output with the speaker 152, the audio device 150 may identify a sleep state of the wearer (e.g., user 101) of the audio device 150. The sleep state may be a sleeping state in which the wearer has fallen asleep, or a transitional sleep state, in which the wearer is falling asleep, or waking up. Identifying the sleep state may include identifying a lack of motion of the wearer and/or a reduction in the motion of the wearer (e.g., using sensors 204), and/or identifying a reduction in breathing rate of the wearer and/or a characteristic breathing attribute of a person in a sleep state (e.g., using sensors 204 and/or microphones 206). Identifying the sleep state may include providing sensor signals from the sensor(s) 204 and/or microphone signals from the microphone(s) 206 to one or more machine learning models at the audio device 150 that have been trained to identify a sleep state of a general user or a specific user (e.g., the user 101) based on sensor signals and/or microphone signals. For example, the sensor signals, microphone signals, and/or machine learning models may be processed and/or executed by the processing circuitry 202. In one or more implementations, a sleep state that may be identified using the audio device 150 may include one or more sub-states, such as rapid eye movement (REM) sleep, non-REM sleep, deep sleep, and/or light sleep.

As shown, responsive to identifying the sleep state of the wearer, the audio device 150 generates a second audio output that is different from the first audio output. For example, in a use case in which the first audio output includes media content and the sleep state is a sleeping state or a transitional sleep state in which the wearer is falling asleep, the second audio output may include (i) the same media content at a reduced volume, (ii) different media content (e.g., the first audio output may include first media content including high energy music with large amplitude variations, such as rock music, rap music, or heavy metal music, and the second audio content may include second media content including meditation music, classical music, white noise, nature sounds, or other media content with reduced amplitude variations), and/or (iii) the same media content with a modified equalization (e.g., reductions of some audio frequencies and/or reductions of transient amplitude spikes, such as drum beats, at one or more frequencies) and/or a reduced dynamic range.

In another example, the audio device 150 may pause the audio output from the speaker 152 responsive to identifying the sleep state. In a use case in which the audio output is paused responsive to identification of the sleep state, the playback time at which the audio content was paused may be set back (e.g., rewinded), such as by few seconds (e.g., three seconds, five seconds, or ten seconds), relative to the time at which the pause occurred. In this way, when the playback is resumed (e.g., automatically upon detecting an awake state of the wearer, or responsive to a user input after wakeup), the playback can resume at or near the last point the wearer remembers hearing the playback (e.g., to account for a lag between the wearer falling asleep and the pausing). In one or more implementations, video content or other visual content (e.g., being output by a display of another device, such as the electronic device 104, the electronic device 110, or the electronic device 115, or a device (e.g., an HMD) within which the audio device is implemented) that corresponds to the audio output may also be paused and/or rewinded responsive to identifying the sleep state. In one or more other implementations, responsive to identifying the sleep state, a marker may be stored that identifies the point in time at which the sleep state was identified (e.g., and the audio and/or video content may be allowed to continue playing). In these implementations, the audio device may later determine that the user has woken up, and provide an option to the user/wearer to return the playback to point in time corresponding to the stored marker.

As another example, in a use case in which the first audio output includes audio content for controlling pass-through of environmental sounds (e.g., by performing noise cancellation and/or selectively including pass-through content) and the sleep state is a sleeping state or a transitional sleep state in which the wearer is falling asleep, the second audio content may include a modification of the audio content for controlling the pass-through of environmental sounds. For example, in a use case in which the first audio output includes noise cancellation content, the second audio content may include an increased amount of overall noise cancellation content (e.g., to further reduce environmental noise that reaches the wearer’s ear), a modified adaptivity of the noise cancelling content, and/or a reduction of binaural coordination of the noise cancellation content.

For example, during normal operation of ANC (e.g., while the wearer is in a wake state), the noise cancellation content may be adaptively increased due to a transient sound, such as a passing car or train. In a use case in which media content is being output along with the noise cancellation content, the volume of the media content can also be increased along with the increase in noise cancellation content due to the transient sound. However, when a person is sleeping or falling asleep, it may be more disruptive to the wearer’s sleep state to rapidly increase noise cancellation and/or media content volume. In one or more implementations, when the sleep state is identified, the adaptivity of the ANC operation to transient sounds may be reduced or turned off to avoid rapid changes in the amount of noise cancellation content.

As another example, an ANC operation may be a binaural ANC operation, in which noise cancellation content generated by speakers or earbuds or headphones for the two respective ears of the wearer is coordinated using communications between the earbuds or headphones for each ear. This can be beneficial for reducing environmental sounds that are located on one side of the user, and/or environmental sounds from noise sources that are moving relative to the user. This can also be useful if the speakers or earbuds or headphones for the two respective ears of the wearer individually perform ANC operations using their own microphones, such as to avoid binaural artifacts from independent ANC control for the two respective ears. However, these binaural ANC operations are more power and compute consuming than ANC operations that are uncoordinated for the different ears of the wearer, and a wearer may be less aware of binaural noise effects and/or artifacts when in a sleep state. Accordingly, in some use cases, responsive to identifying the sleep state, binaural coordination of ANC operations of the audio device 150 may be reduced, paused, or stopped. In one or more implementations, reducing or pausing the coordination of ANC operations may include reducing or ceasing communications between a right device (e.g., a right earbud or headphone for a right ear of the user) and a left device (e.g., a left earbud or headphone for a left ear of the user).

In a use case in which the first audio output includes pass-through content for a (e.g., predetermined) set of selected sounds, the second audio output may include pass-through content for a modified set of selected sounds that are passed through the audio device 150 by the speaker 152. For example, the modified set of selected sounds may be a subset of the set of sounds. The subset may be selected by the user, and/or may include a default set of sounds, such as station announcements, bus stop announcements, alarms, doorbells, or the like.

In one or more implementations, the second audio content may include changes, relative to the first audio content, based on an estimated accumulated sound exposure to the wearer during sleep. For example, the audio device and/or a companion device may determine that the first audio output and/or environmental noise may cause temporary or permanent hearing damage to the wearer if continued while the user is asleep (e.g., over a period of time that is extended due to the user’s sleep state, and/or that is a length of time of which the user may be unaware due to the user’s sleep state). For example, the media content volume, dynamic range, and/or EQ may be modified to levels that prevent hearing damage due to prolonged exposure (e.g., over minutes or hours), and/or noise cancellation can be increased to reduce environmental sounds to levels that prevent hearing damage due to prolonged exposure. In one or more implementations, the modifications may be made based on an expected sleep duration for the sleep state of the wearer (e.g., learned by the audio device and/or the companion device based on prior sleeps by the wearer, such as for overnight sleeps and/or naps at particular times of day).

In one or more use cases, the second audio output may be selected to aid the wearer in falling asleep when a transitional sleep state is detected (e.g., by modifying the audio output to include sleep-aid content, such as meditation music, classical music, white noise, nature sounds, a sleep playlist previously determined by or for the wearer, or other media content with reduced amplitude variations). In one or more other use cases, the second audio content may be selected to aid the wearer in waking up or staying awake when a transitional sleep state is detected. For example, the second audio output may reduce the noise cancellation content, increase pass-through of environmental sounds, increase the set of sounds that are passed through, and/or modify media content to more energetic and/or higher volume audio content to aid the wearer in waking up or staying awake. In one or more implementations, the audio device 150 (e.g., and/or a companion device) may determine whether to modify the audio output to aid in falling asleep or to aid in staying awake based on one or more other signals, such as a location of the wearer (e.g., a wearer in their bed or on their couch may desire to fall asleep, whereas a wearer at their desk, at work, or on a train or a bus and within a few stops or minutes of their destination may desire to stay awake), calendar information for the wearer (e.g., a wearer with an upcoming appointment in their calendar may desire to stay awake), environmental information (e.g., people and/or events taking place around the wearer), or the like.

In one or more implementations, the second audio output may be generated responsive to an identified change in sub-states of a sleep state. For example, white noise output and/or noise-cancellation output may be suspended or reduced when a user is in a REM state or a deep sleep state, and resumed when the user is in a light sleep state or a non-REM state (e.g., to aid the user in remaining asleep during lighter stages of sleep).

In one or more implementations, the audio device 150 may wait for a period of time (e.g., one minute, several minutes, or a fraction of a minute) after an initial identification of a sleep state of a user before modifying the audio output to the second audio output. For example, the audio device 150, responsive to an initial sleep state detection (e.g., based on motion, or lack of motion, of the user) may perform one or more confirmation operations (e.g., by monitoring for user inputs to the audio device 150, other indicators of a wake state of the user, such as a detection of the user’s own voice, and/or subsequent movements of the audio device 150) before modifying the audio output.

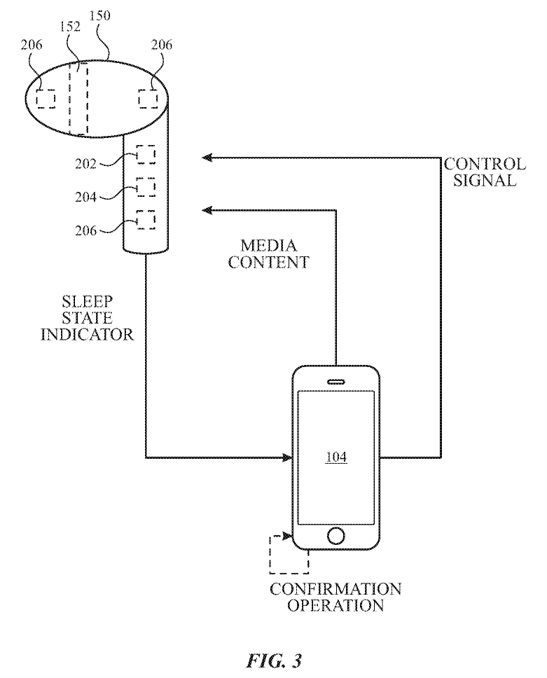

In the example of FIG. 2, while the first audio content is being output, the sleep state and/or sub-state is identified, and the second audio content is output by the audio device 150. In one or more implementations, some portions of these processes and/or related supporting processes may be performed by one or more other devices, such as a companion device (also referred to herein as a source device in some examples in which the companion device acts as source of media content for the audio device). For example, FIG. 3 illustrates an implementation in which the electronic device 104 acts as a companion device to the audio device 150. As shown, the electronic device 104 may provide (e.g., wirelessly, such as via a Bluetooth connection, a WiFi connection, or other wireless connection) media content to the audio device 150. The audio device 150 may generate the first audio output of FIG. 2 based on the media content received from the electronic device 104, in some use cases.

In the example of FIG. 3, a sleep state is detected by the audio device 150 (e.g., by the processing circuitry 202 using the sensor(s) 204 and/or the microphone(s) 206, as described above), and a sleep state indicator may be provided (e.g., wirelessly) to the electronic device 104. For example, the sleep state indicator may indicate an identified sleep state (e.g., a sleeping state or a transitional sleep state, as discussed herein) of the user 101.

In this example, the electronic device 104 may provide, responsive to receiving the sleep state indicator, modified media content and/or one or more control signals to the audio device 150. The modified media content and/or the control signal(s) may cause the change from the first audio output to the second audio output at the audio device 150. For example, the modified media content may be paused media content (e.g., the electronic device 104 may cease providing the media content to the audio device and may store a playback time at which the media content was paused), reduced volume medial content, modified EQ media content, and/or different media content (e.g., sleep-friendly or sleep-aid media content). For example, the control signal(s) may include control signals that cause a change in noise cancellation content and/or pass-through content in the output of the speaker 152 of the audio device 150, as described above in connection with FIG. 2.

In one or more implementations, after receiving the sleep state indicator from the audio device 150, the electronic device 104 may wait for a period of time (e.g., one minute, several minutes, or a fraction of a minute) before modifying the media content that is provided to the audio device 150. For example, responsive to receiving the sleep state indicator, the electronic device 104 may perform one or more confirmation operations (e.g., by monitoring for user inputs to the electronic device 104 and/or movements of the electronic device 104) before modifying the audio output.

For example, in a use case in which a user (e.g., user 101) of the electronic device 104 that also is wearing the audio device 150 while the audio device 150 is outputting media content received from the electronic device 104 (e.g., acting as a source device) is sitting substantially motionless (e.g., while watching video content or listening to music or a podcast with eyes closed), the user may still be scrolling through other content on the electronic device 104 or otherwise interacting with and/or moving the electronic device 104. The electronic device 104 may determine whether to modify the media content being provided to the audio device 150 (e.g., by pausing the media content) based on the sleep state indicator and the monitoring of user activity at the electronic device 104 during a confirmation period of time. In one or more implementations, the electronic device 104 may also wait for a second period of time (e.g., one minute or a fraction of a minute) before rewinding the media content following pausing the media content (e.g., to await a user input to the electronic device 104 or the audio device 150 resuming the playback of the media content, such as in a use case in which the confirmation operation did not detect user activity, but the user is not sleeping, such as due to the user being in a meditative state listening to the media content).

In one or more implementations, memory of the electronic device 104 may store one or more machine learning models and/or one or more rules-based processes for confirming whether the user of the electronic device 104 (e.g., who is also a wearer of the audio device 150) is in the sleep state indicated by the audio device 150. For example, a machine learning model and/or a rules-based process at the electronic device 104 may monitor signals, from one or more microphone(s), IMU sensor(s), input components (e.g., touchscreen, touchpad, button, switch, or the like) and/or other components, for indicators of user activity and/or device motion of the electronic device 104. In one or more implementations, if no user activity or device motion is detected within the period of time, the electronic device 104 may determine that sleep has been detected, and may modify the output of the media content as discussed herein. If user activity and/or device motion is detected within the period of time, the electronic device 104 may determine the user is awake and may refrain from modifying the output of the media content. In one or more implementations, this confirmation operation at the electronic device 104 may mitigate potential effects of hysteresis at the audio device.

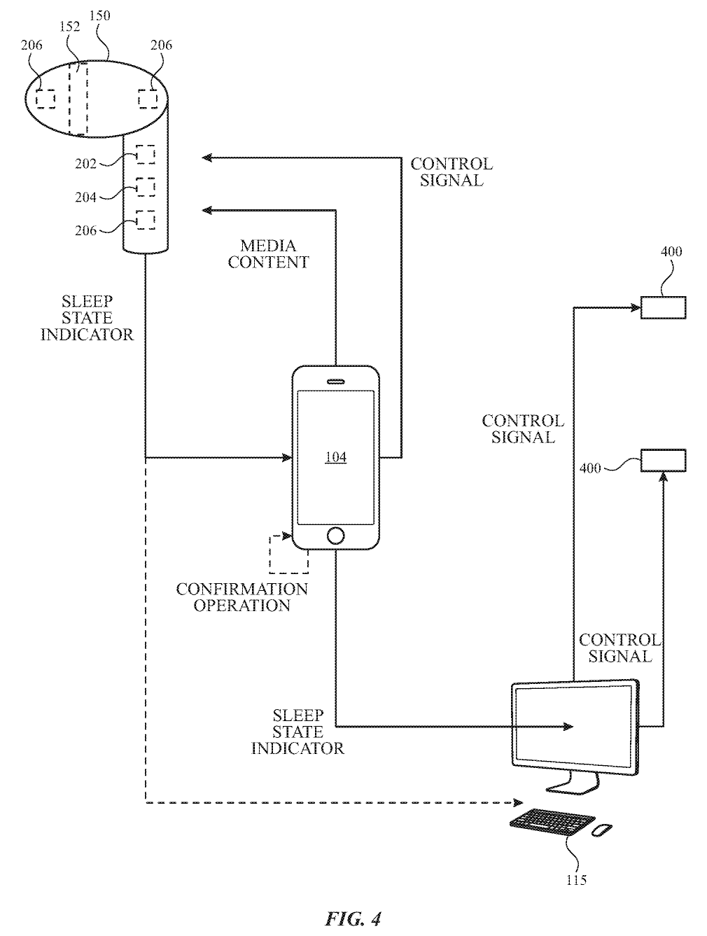

In one or more implementations, the audio device 150 and/or the electronic device 104 may provide the sleep indicator to one or more other devices. For example, FIG. 4 illustrates an implementation in which the electronic device 115 is communicatively coupled to one or more controllable devices 400. As examples, the controllable devices 400 may include smart light bulbs, smart lamps or other smart light sources, smart locks (e.g., door locks, window locks), alarm system components, climate control devices and/or components, or other devices and/or components that are controllable by the electronic device 115. As shown, the audio device 150 and/or the electronic device 104 may provide the sleep state indicator to the electronic device 104, and the electronic device 115 may, responsively, generate one or more control signals and provide the one or more control signals to the controllable devices 400.

For example, the user 101 may be sitting in their living room or bedroom, and may fall asleep while wearing the audio device 150. When the audio device 150 identifies the sleep state of the user 101, the audio device 150 may communicate the sleep state indicator to the electronic device 104 and/or the electronic device 115. Responsive to receiving the sleep state indicator (e.g., from the audio device 150 or from the electronic device 104, such as following a confirmation operation at the electronic device 104 in some implementations), the electronic device 115 may generate the control signals to dim or turn off the lights in the living room or bedroom, to lock the doors and/or windows of the house, apartment, or building in which the user 101 is located, to modify one or more climate settings (e.g., a temperature, a humidity, etc.) of a climate control system of the house, apartment, or building in which the user 101 is located, and/or to arm an alarm system of the house, apartment, or building. These examples of lights, door locks, climate control systems, and alarm systems are merely illustrative, and the electronic device 115 may be communicatively coupled to other controllable devices 400, and configured to generate control signals for the other controllable devices 400 based on a received sleep indicator.

In one or more implementations, operations to detect sleep and/or changes to the audio output of the audio device 150, and/or changes to control of the controllable devices 400 responsive to sleep detection may be contingent on one or more criteria, such as at least one earbud or headphone being worn by a wearer, and/or a single-user criterion. For example, the single-user criterion may prevent changes to the audio output of the audio device 150 and/or changes in the control of the controllable devices 400 if another user is present and/or using the audio device 150. For example, if the user 101 wears one earbud of a pair of earbuds to listen to media content, and allows another user to wear the other earbud of the pair of earbuds to share in listening to the media content (e.g., or if a wireless splitter is used to route the media content to two separate pairs of earbuds or headphones), the audio output from the earbuds (e.g., or the audio output from the other earbud) may not be modified, even if a sleep state of the user 101 is identified. As another example, if the user 101 is wearing their earbuds in their living room and falls asleep, the operation of the controllable devices 400 (e.g., lights, door locks, etc.) may not be modified if there is another person present in the living room (e.g., as detected by the electronic device 104 and/or the electronic device 115).

FIG. 5 illustrates a flow diagram of an example process 500 that may be performed for operating an audio device based on sleep detection in accordance with implementations of the subject technology. For explanatory purposes, the process 500 is primarily described herein with reference to the audio device 150 and electronic device 104 of FIGS. 1-4. However, the process 500 is not limited to the audio device 150 and electronic device 104 of FIGS. 1-4 , and one or more blocks (or operations) of the process 500 may be performed by one or more other components of other suitable devices, including the electronic device 110, the electronic device 115, and/or the servers 120. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

As illustrated in FIG. 5, at block 502, a wearable audio device (e.g., audio device 150) that is being worn by a wearer (e.g., user 101) may receive (e.g., over a wired or wireless connection) media content (e.g., music, podcast content, audio content corresponding to a video or a game, etc.) from a remote device (e.g., a companion device, such as, electronic device 104).

At block 504, the wearable audio device that is being worn by the wearer may identify, while the wearable audio device is outputting the media content with a speaker (e.g., speaker 152) of the wearable audio device, a sleep state corresponding to the wearer. The sleep state may be a sleeping state in which the wearer is asleep, or a transitional sleep state in which the wearer is falling asleep or waking up. The sleep state may be identified by the wearable audio device using one or more sensors (e.g., sensor 204), one or more microphones (e.g., microphones 206), and/or a machine learning model trained to identify the sleep state based on sensor data from the one or more sensors and/or microphone signals from the one or more microphones.

At block 506, the wearable audio device may modify the outputting of the media content responsive to the identifying of the sleep state. For example, modifying the outputting of the media content may include pausing the outputting of the media content. For example, pausing the outputting of the media content may include pausing the outputting of the media content at a playback time within the media content. The process 500 may also include modifying (e.g., by the remote device) the playback time to an earlier playback time (e.g., a few second earlier, such as five seconds earlier) within the media content for later resumption (e.g., automatically upon detection of an awake state of the wearer, or responsive to a later use input to the wearable audio device or the remote device) of the outputting of the media content starting at the earlier playback time within the media content.

In one or more implementations, prior to pausing the media content, the wearable audio device or the remote device may determine that the media content comprises pause-able media content. For example, pause-able media content may include music, podcast content, and/or audio content corresponding to a video or a game, etc. In some examples, the determination of whether the media content is pause-able may be based on the application that is providing the media content for output. For example, media content being provided by a media player application may be pause-able, and media content being provided from a social media application (e.g., embedded within a social media feed) may be non-pause-able, in some implementations. In other implementations, all media content may be pause-able, and other non-media content may be non-pause-able content. As examples, non-pause-able non-media content may include notifications (e.g., message notifications, call notifications, calendar notifications), system sounds, alarms, or the like. In some examples, non-pause-able non-media content may be silenced separately and independently of the sleep state of the user 101.

In one or more implementations, the process 500 may also include providing, responsive to the identifying, a sleep state indicator to the remote device (e.g., as discussed herein in connection with FIG. 3). For example, modifying the outputting of the media content may include modifying the outputting responsive to a modification to the media content (e.g., and/or one or more control signals) received from the remote device (e.g., responsive to providing the sleep state indicator). For example, the remote device may modify the media content responsive to receiving the sleep state indicator.

In one or more implementations, modifying the outputting of the media content may include reducing a volume of the outputting of the media content. For example, reducing the volume may include reducing the volume from a current volume to a reduced volume at a predetermined volume-reduction rate. For example, the predetermined volume-reduction rate may cause the volume to be reduced over a period of time (e.g., half a minute, one minute, or several minutes) that avoids sudden (e.g., sub-second, or one second) volume changes that could wake the wearer or prevent the wearer from falling asleep.

In one or more implementations, modifying the outputting of the media content may include performing a hearing-protection modification to the outputting of the media content. For example, the hearing-protection modification may include a modification of an equalization of the media content. As another example, the hearing-protection modification may include a modification (e.g., a reduction in volume, a suppression of high-amplitude transients, a suppression of certain frequencies, a gradual or stepped reduction in volume) to prevent accumulated exposure that crosses a hearing-damage threshold. In one or more implementations, the audio device or the companion device may estimate an expected length of time the wearer will be asleep, and apply the hearing-protection modification of the outputting of the media content to prevent temporary or permanent hearing loss from exposure to the media content over that expected length of time. In one or more other implementations, the hearing-protection modification may occasionally and/or periodically increase the reduction in volume or EQ adjustment as the time the wearer is asleep increases (e.g., to account for the increasing amount of exposure time as the wearer stays asleep).

In one or more implementations, modifying the outputting may include outputting second media content different from the media content. For example, the second media content may include sleep-aid media content. Sleep-aid media content may be media content selected and/or configured to aid the wearer in falling asleep. As examples, sleep-aid media content may include meditation music, classical music, white noise, nature sounds, a sleep playlist previously determined by or for the wearer, or other media content with reduced volume and/or reduced amplitude variations relative to the media content.

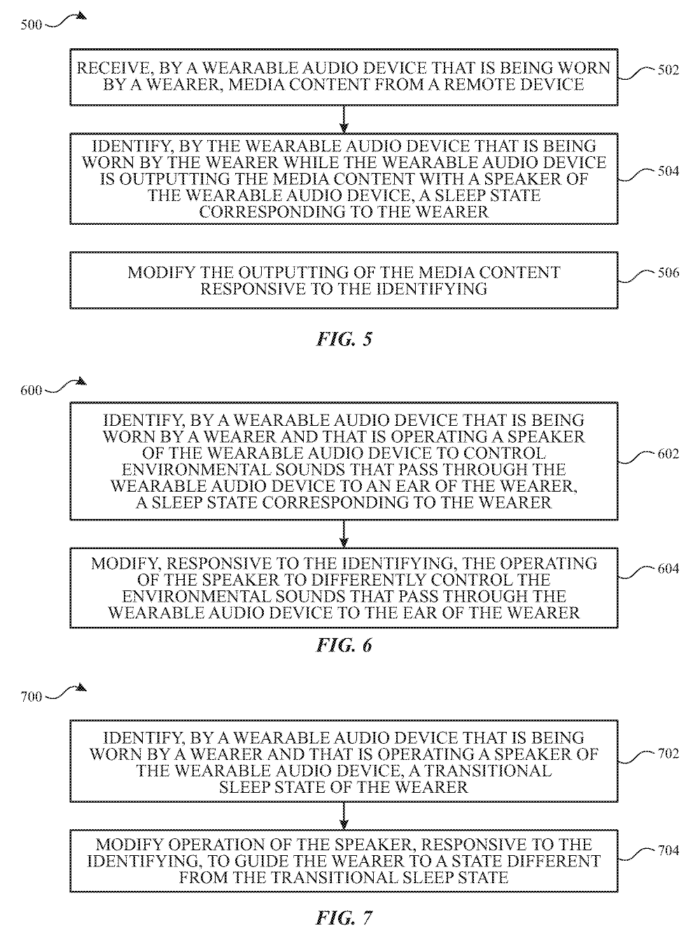

FIG. 6 illustrates a flow diagram of an example process 600 that may be performed for operating an audio device based on sleep detection in accordance with implementations of the subject technology. For explanatory purposes, the process 600 is primarily described herein with reference to the audio device 150 and electronic device 104 of FIGS. 1-4. However, the process 600 is not limited to the audio device 150 and electronic device 104 of FIGS. 1-4, and one or more blocks (or operations) of the process 600 may be performed by one or more other components of other suitable devices, including the electronic device 110, the electronic device 115, and/or the servers 120. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, a wearable audio device (e.g., audio device 150) that is being worn by a wearer (e.g., user 101) may and that is operating a speaker (e.g. speaker 152) of the wearable audio device to control environmental sounds that pass through the wearable audio device to an ear of the wearer may identify a sleep state corresponding to the wearer. The sleep state may be a sleeping state in which the wearer is asleep, or a transitional sleep state in which the wearer is falling asleep or waking up. The sleep state may be identified by the wearable audio device using one or more sensors (e.g., sensor 204), one or more microphones (e.g., microphones 206), and/or a machine learning model trained to identify the sleep state based on sensor data from the one or more sensors and/or microphone signals from the one or more microphones.

At block 604, the audio device may modify, responsive to the identifying, the operating of the speaker to differently control the environmental sounds that pass through the wearable audio device to the ear of the wearer. For example, operating the speaker of the wearable audio device to control the environmental sounds that pass through the wearable audio device may include applying an active noise canceling (ANC) operation, and modifying the operating of the speaker to differently control the environmental sounds comprises increasing an amount of the ANC operation. As another example, operating the speaker of the wearable audio device to control the environmental sounds that pass through the wearable audio device may include applying an active noise canceling (ANC) operation, and modifying the operating of the speaker to differently control the environmental sounds may include reducing an adaptiveness of the ANC operation (e.g., by reducing the rate at which the ANC operation adjusts to transient sounds).

As another example, operating the speaker of the wearable audio device to control the environmental sounds that pass through the wearable audio device may include modifying media content output according to a first tuning curve in response to a transient environment sound, and modifying the operating of the speaker to differently control the environmental sounds may include modifying the media content output according to a second tuning curve, different from the first tuning curve, in response to the transient environment sound. For example, the first tuning curve and the second tuning curve may each define an output volume for the media content as a respective function of the amplitude of the external sound.

As another example, the wearable audio device may include a first speaker for a first ear of the wearer (e.g., in a first earbud or a first headphone, such as a right earbud or right headphone for a right ear of the wearer) and a second speaker for a second ear of the wearer (e.g., in a second earbud or a second headphone, such as a left earbud or left headphone for a left ear of the wearer). In this example, operating the speaker of the wearable audio device to control the environmental sounds that pass through the wearable audio device may include applying a first active noise canceling (ANC) operation that coordinates operation of the first speaker and the second speaker. In this example, modifying the operating of the speaker to differently control the environmental sounds may include applying a second ANC operation that independently operates the first speaker and the second speaker (e.g., without communication between the first earbud or headphone and the second earbud or headphone). For example, the second ANC operation may be a power-saving ANC operation (e.g., that reduces power consumption by reducing or eliminating communication between the left and right earbuds or headphones to coordinate the ANC operation).

FIG. 7 illustrates a flow diagram of an example process 700 that may be performed for operating an audio device based on sleep detection in accordance with implementations of the subject technology. For explanatory purposes, the process 700 is primarily described herein with reference to the audio device 150 and electronic device 104 of FIGS. 1-4. However, the process 700 is not limited to the audio device 150 and electronic device 104 of FIGS. 1-4, and one or more blocks (or operations) of the process 700 may be performed by one or more other components of other suitable devices, including the electronic device 110, the electronic device 115, and/or the servers 120. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, a wearable audio device (e.g., audio device 150) that is being worn by a wearer (e.g., user 101) may and that is operating a speaker (e.g. speaker 152) of the wearable audio device may identify a transitional sleep state corresponding to the wearer. The transitional sleep state may be a state in which the wearer is falling asleep or waking up. The transitional sleep state may be identified by the wearable audio device using one or more sensors (e.g., sensor 204), one or more microphones (e.g., microphones 206), and/or a machine learning model trained to identify the transitional sleep state based on sensor data from the one or more sensors and/or microphone signals from the one or more microphones. For example, the transitional sleep state may be identified based on a reduction in movement of the user and/or a slowing breathing rate of the user following a period of being awake, or an increase in movement of the user and/or an increase in a breathing rete of the user following a period of being in a sleeping state.

At block 704, the wearable audio device may modify operation of the speaker, responsive to the identifying, to guide the wearer to a state different from the transitional sleep state. For example, the state different from the transitional sleep state may include a sleep state (e.g., a sleeping state). For example, operating the speaker may include outputting first media content, and modifying the operation of the speaker may include outputting second media content different from the first media content. For example, the second media content may include sleep-aid media content.

In one or more implementations, operating the speaker may include operating the speaker to pass a set of environmental sounds through the wearable audio device to an ear of the wearer, and modifying the operation of the speaker may include operating the speaker to pass only a subset of the set of environmental sounds through the wearable audio device to the ear of the wearer.

In one or more implementations, the process 700 may also include providing, from the wearable audio device to another device (e.g., the electronic device 115), an indication of the sleep state. For example, the other device may be configured to control one or more devices (e.g., controllable devices 400) in a home of the wearer responsive to the indication of the sleep state.

In one or more implementations, the state different from the transitional sleep state may include an awake state. For example, operating the speaker may include operating the speaker to pass a first set of environmental sounds through the wearable audio device to an ear of the wearer, and modifying the operation of the speaker may include operating the speaker to pass a second set of environmental sounds, different from the first set of environmental sounds, through the wearable audio device to the ear of the wearer.

In one or more implementations, a companion device (e.g., electronic device 104) may receive a sleep state indicator from an audio device (e.g., audio device 150). The companion device may modify media content that is being provided to the audio device for output by a speaker of the audio device, based on the sleep state indicator. The companion device may generate, based on the sleep state indicator, one or more control signals, and provide the one or more control signals to the audio device. The one or more control signals may modify an active noise cancellation (ANC) operation and/or a pass-through audio operation at the audio device. In one or more implementations, the companion device may provide the sleep state indicator to another device (e.g., a home hub or home controller device) that is configured to operate one or more controllable devices (e.g., controllable devices 400) based on the sleep state indicator (e.g., as described in connection with FIG. 4).

In one or more implementations, a device (e.g., (a home hub or home controller device, such as the electronic device 115) may receive (e.g., from an audio device or a companion device of the audio device) a sleep state indicator. The device may control (e.g., by generating one or more control signals) one or more controllable devices (e.g., controllable devices 400) based on the sleep state indicator (e.g., as described in connection with FIG. 4).

FIG. 8 illustrates a flow diagram of an example process 800 that may be performed for operating a source device based on sleep detection in accordance with implementations of the subject technology. For explanatory purposes, the process 800 is primarily described herein with reference to the electronic device 104 and the audio device 150 of FIGS. 1-4. However, the process 800 is not limited to the electronic device 104 and the audio device 150 of FIGS. 1-4, and one or more blocks (or operations) of the process 800 may be performed by one or more other components of other suitable devices, including the electronic device 110, the electronic device 115, and/or the servers 120. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, a source device (e.g., electronic device 104) that is providing media content to an audio output device (e.g., audio device 150) for output from the audio output device may receive, from the audio output device, a sleep state indicator for a user (e.g., user 101) of the source device (e.g., as described in connection with FIGS. 2 and/or 3).

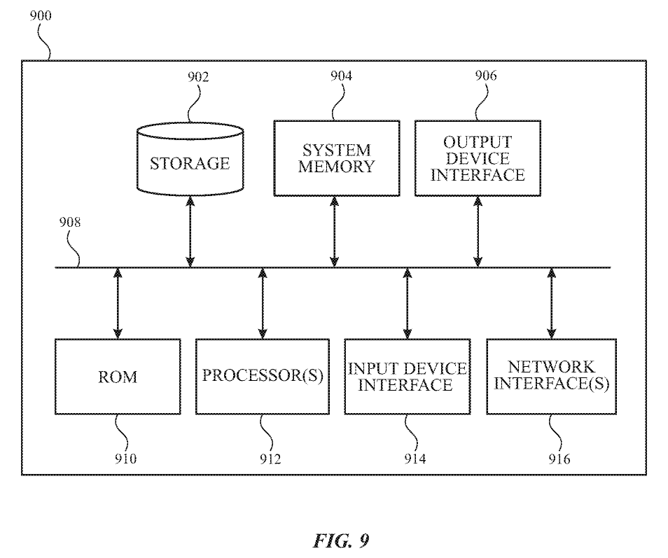

At block 804, the source device (e.g., one or more processors at the source device, such as a processor 912 of FIG. 9) may monitor (e.g., using one or more sensors and/or input components of the source device), responsive to receiving the sleep state indicator and for a first period of time (e.g., five minutes, three minutes, one minute, a fraction of a minute), user activity at the source device. For example, the user activity may include one or more user inputs to the source device, such as scrolling, keypad interaction, trackpad interaction, touchscreen interaction, voice input, button presses, switch actuations, and/or other user inputs to the source device. As another example, the user activity may include movement of the source device (e.g., due to the user of the source device walking, standing, sitting down, or otherwise moving while holding or carrying the source device). For example, movement of the source device may be monitored by a processor of the source device using sensor signals from one or more motion sensors (e.g., accelerometers, gyroscopes, compasses, or the like) at the source device.

At block 806, the source device may determine, following the first period of time and based on the sleep state indicator and the monitoring, whether to modify the providing of the media content to the audio output device. In this way, in one or more implementations, the source device may perform a confirmation operation, responsive to receiving the sleep state indicator and using one or more sensors and/or components of the source device, to confirm a sleep state of the user prior to making the modification.

In one example use case, the user may not be sleeping, but may be sitting still enough to indicate a potential sleep state to the audio output device. However, if the user is interacting with the source device and/or moving the source device, the source device may determine that the user is not sleeping (e.g., even though a sleep state indicator has been received from the audio device) and may determine not to modify the providing of the media content to the audio output device. For example, determining whether to modify the providing of the media content to the audio output device may include identifying a user input to the source device during the first period of time, and the source device may determine not to modify the providing of the media content responsive to identifying the user input. As another example, determining whether to modify the providing of the media content to the audio output device may include identifying a motion of the source device during the first period of time, and the source device may determine not to modify the providing of the media content responsive to identifying the motion.

In one or more use cases (e.g., a use case in which the user is sleeping), determining whether to modify the providing of the media content to the audio output device may include identifying a sleep state of the user based on the sleep state indicator and the monitoring (e.g., in a case in which the monitoring does not detect any user interaction with the source device and/or user movement of the source device), and the source device may also modify the providing of the media content responsive to identifying the sleep state. In one or more implementations, modifying the providing of the media content may include pausing playback of the media content. For example, pausing the playback of the media content may include discontinuing providing the media content to the audio device and storing a playback time within the playback of the media content at which the pause occurred, to allow resumption of playback at the paused playback time.

In one or more use cases, even if the confirmation operation indicates that the user is sleeping, the user may be awake and desire to continue playback of the media content. For example, (e.g., in a use case in which the user is not sleeping, but is sitting still enough to indicate a potential sleep state, and is also not interacting with the source device, such as if the user is meditating), the source device may receive, within a second period of time (e.g., one minute or a fraction of a minute) after the pausing, a user input at the source device (e.g., the user may reject the pausing or push a play button on a user interface of the source device, or may provide an input to the audio output device to resume playback), and the source device may resume providing the media content to the audio output device at a playback time at which the playback of the media content was paused (e.g., without rewinding the media content).

However, in one or more use cases in which no user input is received during the second period of time, following the second period of time after the pausing without receiving a user input at the source device, the source device may determine an estimated time at which the user fell asleep (e.g., a time before the time at which the playback was paused, such as due to the waiting for the first period of time and/or the second period of time), and may rewind the paused playback of the media content to a playback time that coincided with the estimated time at which the user fell asleep. For example, the estimated time may be time at which the sleep state indicator was generated at the audio output device or received at the source device.

In one or more use cases, the source device may resume the playback at the rewound playback time responsive to at least one of: a user input, or a detected change in the sleep state of the user (e.g., a detected transitional sleep state corresponding to the user waking up, or a detected wake state of the user).

In one or more implementations, the source device may, prior to receiving the sleep state indicator, receive a user input (e.g., via a user interface displayed by the source device, via another user input component, or via a voice input from the user) to enable modifying of media playback based on sleep state detection. Sleep detection, and/or modifying of media playback based on sleep state detection may also be disabled by the user.

As described above, one aspect of the present technology is the gathering and use of data available from specific and legitimate sources for training and/or operating machine learning models. The present disclosure contemplates that in some instances, this gathered data may include personal information data that uniquely identifies or can be used to identify a specific person. Such personal information data can include voice samples, voice profiles, demographic data, location-based data, online identifiers, telephone numbers, email addresses, home addresses, biometric data or records relating to a user’s health or level of fitness (e.g., vital signs measurements, medication information, exercise information, motion information, breathing information, heart rate information), date of birth, or any other personal information.

The present disclosure recognizes that the use of such personal information data, in the present technology, can be used to the benefit of users. For example, the personal information data can be used for modifying audio device operation based on sleep detection.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of modifying audio device operation based on sleep detection, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 9 illustrates an electronic system 900 with which one or more implementations of the subject technology may be implemented. The electronic system 900 can be, and/or can be a part of, the audio device 150, the electronic device 104, the electronic device 110, the electronic device 115, and/or the server 120 as shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a floppy disk, flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910 (which are each implemented as a non-transitory computer-readable medium). From these various memory units, the one or more processing unit(s) 912 retrieves instructions to execute and data to process in order to execute the processes of one or more implementations.

The bus 908 also connects to the input and output device interfaces 914 and 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A method, comprising:
receiving, by a wearable audio device that is being worn by a wearer, media content from a remote device;
identifying, by the wearable audio device that is being worn by the wearer while the wearable audio device is outputting the media content with a speaker of the wearable audio device, a sleep state corresponding to the wearer; and
modifying the outputting of the media content responsive to the identifying.

2. The method of claim 1, wherein modifying the outputting of the media content comprises pausing the outputting of the media content.

3. The method of claim 2, wherein pausing the outputting of the media content comprises pausing the outputting of the media content at a playback time within the media content, the method further comprising modifying the playback time to an earlier playback time within the media content for later resumption of the outputting of the media content starting at the earlier playback time within the media content.

4. The method of claim 2, further comprising, prior to pausing the media content, determining that the media content comprises pause-able media content.

5. The method of claim 1, further comprising:
providing, responsive to the identifying, a sleep state indicator to the remote device,
wherein modifying the outputting of the media content comprises modifying the outputting responsive to a modification to the media content received from the remote device.

6. The method of claim 1, wherein modifying the outputting of the media content comprises reducing a volume of the outputting of the media content.

7. The method of claim 6, wherein reducing the volume comprises reducing the volume from a current volume to a reduced volume at a predetermined volume-reduction rate.

8. The method of claim 1, wherein modifying the outputting of the media content comprises performing a hearing-protection modification to the outputting of the media content.

9. The method of claim 8, wherein the hearing-protection modification comprises a modification of an equalization of the media content.

10. The method of claim 8, wherein the hearing-protection modification comprises a modification to prevent accumulated exposure that crosses a hearing-damage threshold.

11. The method of claim 1, wherein modifying the outputting comprises outputting second media content different from the media content, wherein the second media content comprises sleep-aid media content.

12. A wearable audio device, comprising:
a speaker; and
one or more processors configured to perform operations comprising:
identifying, by the wearable audio device while the wearable audio device is being worn by a wearer and that is operating the speaker of the wearable audio device to control environmental sounds that pass through the wearable audio device to an ear of the wearer, a sleep state corresponding to the wearer; and
modifying, responsive to the identifying, the operating of the speaker to differently control the environmental sounds that pass through the wearable audio device to the ear of the wearer.

13. The wearable audio device of claim 12, wherein operating the speaker of the wearable audio device to control the environmental sounds that pass through the wearable audio device comprises applying an active noise canceling (ANC) operation, and wherein modifying the operating of the speaker to differently control the environmental sounds comprises increasing an amount of the ANC operation.

14. The wearable audio device of claim 12, wherein operating the speaker of the wearable audio device to control the environmental sounds that pass through the wearable audio device comprises applying an active noise canceling (ANC) operation, and wherein modifying the operating of the speaker to differently control the environmental sounds comprises reducing an adaptiveness of the ANC operation.

15. The wearable audio device of claim 12, wherein operating the speaker of the wearable audio device to control the environmental sounds that pass through the wearable audio device comprises modifying media content output according to a first tuning curve in response to a transient environment sound, and wherein modifying the operating of the speaker to differently control the environmental sounds comprises modifying the media content output according to a second tuning curve, different from the first tuning curve, in response to the transient environment sound.

16. The wearable audio device of claim 12, wherein the speaker comprises a first speaker for a first ear of the wearer, wherein the wearable audio device comprises a second speaker for a second ear of the wearer, wherein operating the speaker of the wearable audio device to control the environmental sounds that pass through the wearable audio device comprises applying a first active noise canceling (ANC) operation that coordinates operation of the first speaker and the second speaker, and wherein modifying the operating of the speaker to differently control the environmental sounds comprises applying a second ANC operation that independently operates the first speaker and the second speaker.

17. The wearable audio device of claim 16, wherein the second ANC operation is a power-saving adaptive ANC operation.

18. A non-transitory computer-readable medium storing instructions which, when executed by one or more processors, cause the one or more processors to perform operations, comprising:
receiving, from an audio output device at a source device that is providing media content to the audio output device for output from the audio output device, a sleep state indicator for a user of the source device;
monitoring, by the source device responsive to receiving the sleep state indicator and for a first period of time, user activity at the source device; and
determining, at the source device following the first period of time and based on the sleep state indicator and the monitoring, whether to modify the providing of the media content to the audio output device.

19. The non-transitory computer-readable medium of claim 18, wherein determining whether to modify the providing of the media content to the audio output device comprises identifying a sleep state of the user based on the sleep state indicator and the monitoring, and wherein the operations further comprise modifying the providing of the media content responsive to identifying the sleep state.

20. The non-transitory computer-readable medium of claim 18, wherein determining whether to modify the providing of the media content to the audio output device comprises:
identifying at least one of:
a user input to the source device during the first period of time, or
a motion of the source device during the first period of time; and
determining not to modify the providing of the media content responsive to identifying the at least one of the user input or the motion.
